(19) United States
(12) Patent Application Publication
(10) Pub. No.: US 2017/0030809 A1
(43) Pub. Date: Feb. 2, 2017

(54) IMPROVEMENTS IN OR RELATING TO FLUID SAMPLING

(71) Applicant: EnDET Limited, Market Drayton, Shropshire (GB)

(72) Inventor: Jeremy KNIGHT, Market Drayton, Shropshire (GB)

(21) Appl. No.: 15/123,844

(22) PCT Filed: Mar. 5, 2015
(86) PCT No.: PCT/GB15/50646

§ 371 Date: Sep. 6, 2016

(30) Foreign Application Priority Data
Mar. 6, 2014 (GB) 1403968.9

(51) Int. Cl. G01N 1/20; B01L 3/00

(52) U.S. Cl. CPC G01N 1/2035; B01L 3/5082; B01L 2200/141; B01L 2300/0832; G01N 2001/205

(57) ABSTRACT

A sampling device comprises a mounting body connectable to a fluid container for housing a fluid requiring sampling. The mounting body has a fluid-sample flow passage opening into a connector recess; a sample-tube connector engaged with the connector recess; and a sample tube which extends from a distal end of the sample-tube connector and tightly engages with the fluid-sample flow passage. A cavity thus defined by the connector recess and the distal end of the sample-tube connector is bridged by the sample tube. The bridging prevents or limits contamination of a fluid sample extracted from a fluid flow in a fluid container to which the device is attached.

The present invention relates to a sampling device, and more particularly but not necessarily exclusively to a process sampling device. The invention also relates to a fluid conduit having such a device, and to a method of preventing or reducing contamination of a fluid sample extracted from a fluid flow in such a fluid conduit, preferably utilising such a device.

When transporting fluids through pipework, which can often be hazardous fluids, such as natural gas or oil, sampling is often required to check and monitor, for example, quality. The sampling is often continuous and extraction of portions to be sampled are extracted through a side wall of the pipe. This is often referred as ‘process sampling’, which is a well-known term in the field relating to fluid which is to be or has been processed and thus sampling apparatus is permanently in place to take samples either continuously or at predetermined intervals to check the integrity of the fluid.

To meet safety requirements, especially when transporting hazardous fluids, which may for example be explosive, more complex valve arrangements are required, such as double block and bleed valves. However, this creates a greater number of interior inferior surface areas, along with so-called ‘dead’ spaces or voids, which can be contaminated over time due to deposited particulate matter, outgassing and moisture ingress. The surfaces within the voids are contaminated by flow circulation, but worsen over time due to sorption issues. For example, a major issue currently being experienced is contamination through the use of sealant at screw-threaded areas. Sorption is an issue with the sealant, such as PTFE tape or paste, resulting in degradation of the associated surfaces. As fluid samples thus pass through the valve body, contamination readily occurs, leading to damage, impairment, spoiling and/or distortion of the integrity of the sample. As such, the results of the sampling process can be inaccurate or unreliable at best, and at worst of no practical use whatsoever. The valve body thus has to be periodically removed for cleaning, but even so as mentioned above this may still not solve the contamination issue. In any event, even for cleaning, this requires the fluid transport in the pipe to be halted, which for commercial reasons may often not be possible.

Although particularly relating to the transport of fluids, being either liquids or gases, within pipes, either to, from or within a refinery, for example, it may also relate more broadly to any housed fluid which requires sampling. The sampling may be continuous, as is preferred with the current invention herein described, or may be periodic or temporary.

The present invention therefore seeks to provide a solution to these problems, preferably but not necessarily exclusively by utilising an existing design of valve body, thereby providing minimal change to existing sampling apparatus.

According to a first aspect of the invention, there is provided a sampling device comprising a mounting body connectable to a fluid conduit for housing a fluid requiring sampling, the mounting body having a fluid-sample flow passage opening into a connector recess; a sample-tube connector engaged with the connector recess; and a sample tube which extends from a distal end of the sample-tube connector and tightly engages with the fluid-sample flow passage, whereby a cavity defined by the connector recess and the distal end of the sample-tube connector is bridged by the sample tube.

Preferably, a proximal end of the fluid-sample flow passage in the mounting body at the connector recess may have a stepped bore.

Furthermore, a first step of the stepped bore may be complementarily shaped to receive an end portion of the sample-tube connector, and the said first step may be adapted to fluid-tightly or substantially fluid-tightly engage with the end portion of the sample tube.

A second step of the stepped bore may be shaped to receive a sealing element for fluid-tightly or substantially fluid-tightly sealing an exterior surface of the sample tube relative to the mounting body. Said sealing element may be an O-ring seal.

Optionally, the sampling device may further comprise a sealing-element retainer engagable with the mounting body for retaining the sealing element in the stepped bore, and the sealing-element retainer may be a plate engagable with an interior surface of the connector recess and through which the sample tube is extendable.

The sampling device may further comprise a sealing-element receiving portion integrally formed with the mounting body as one-piece, the sealing-element receiving portion including an undercut adapted to receive and prevent or limit axial displacement of a sealing element.

The connector recess and the sample-tube connector may include complementary matable screw-threads.

Preferably, the sample-tube connector may include a compressible ferrule for gripping the sample tube.

The sample tube may preferably have a uniform or substantially uniform lateral cross-section along a longitudinal extent of at least a portion extending within the sampling device, and the sample tube may have a uniform unstepped bore within at least a portion extending within the sampling device, the said uniform unstepped bore matching or substantially matching at least a major portion of a bore of the fluid-sample flow passage.

Preferably, the sample tube may be contiguous with the said fluid-sample flow passage.

Optionally, the sample tube may define an isolated flow path through the said cavity.

The sample tube and the fluid-sample flow passage may together solely define a flow path through the mounting body, connector recess, and sample-tube connector, and the said flow path may be straight.

At least a portion of the sample tube within the mounting body may be straight.

Preferably, the mounting body may be part of a valve, and the valve may be a double block and bleed valve. The fluid-sample flow passage may extend from one end of the mounting body to be receivable in a fluid container housing a fluid requiring sampling.

Optionally, the mounting body, sample-tube connector and sample tube may be in the form of a kit of parts.

According to a second aspect of the invention, there is provided a sampling device comprising a mounting body connectable to a fluid conduit for housing a fluid requiring sampling, the mounting body having a fluid-sample flow passage opening into a connector recess; a sample-tube connector engagable with the connector recess; and a sample tube which extends from a distal end of the sample-tube connector and tightly engagable with the fluid-sample flow passage, whereby a cavity defined by the connector recess and the distal end of the sample-tube connector is bridgeable by the sample tube.

According to a third aspect of the invention, there is provided a fluid conduit comprising an elongate hollow tubular body and a sampling device in accordance with the first aspect of the invention connected to a side thereof, the said fluid-sample flow passage extending from the mounting body into an interior of the elongate hollow tubular body.

Preferably, the elongate hollow tubular body is adapted for transporting a hazardous fluid.

According to a fourth aspect of the invention, there is provided a method of preventing or reducing contamination of a fluid sample extracted from a fluid flow in a fluid conduit, the method comprising the step of providing an isolated flow path bridging an internal cavity defined by a connector recess of a mounting body and a distal end of a sample-tube connector, the isolated flow path isolating a sample fluid flow through the said internal cavity.

It is also possible to provide a method of preventing or reducing contamination of a fluid sample extracted from a fluid flow in a fluid conduit using a sampling device in accordance with the first aspect of the invention, the method comprising the step of providing an isolated flow path bridging an internal cavity defined by a connector recess of a mounting body and a distal end of a sample-tube connector, the isolated flow path isolating a sample fluid flow through the said internal cavity.

The invention will now be more particularly described, by way of example only, with reference to the accompanying drawings, in which:

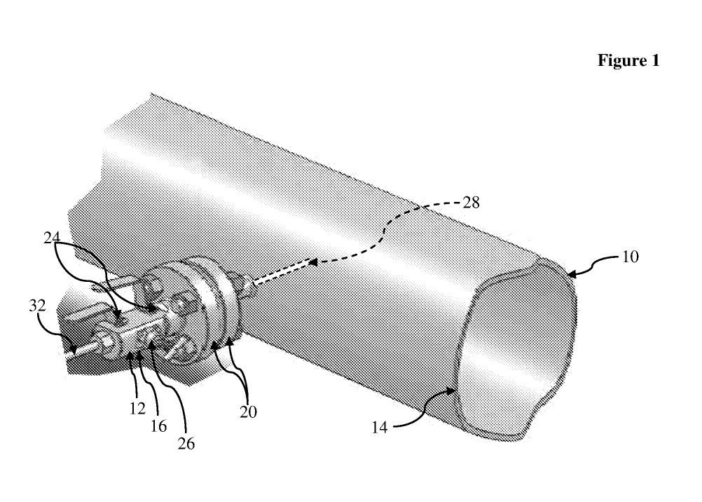

FIG. 1 shows a partial perspective view of one embodiment of a fluid conduit comprising a sampling device, in this case being a process sampling device, in accordance with the present invention;

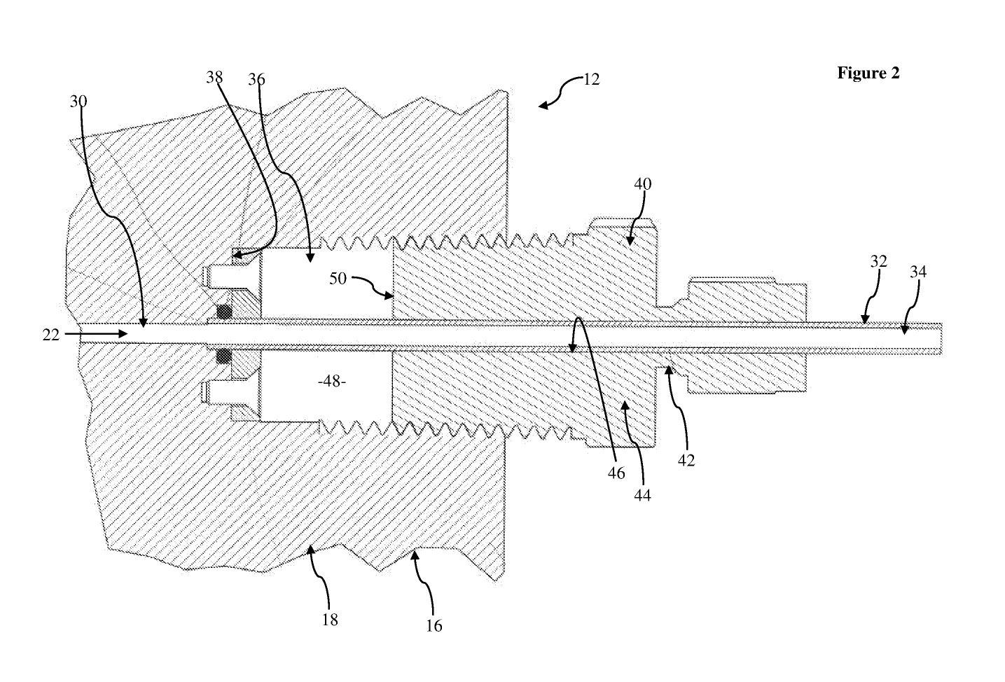

FIG. 2 is an enlarged, partial cross-sectional view through a valve-side part of the sampling device, shown in FIG. 1; and

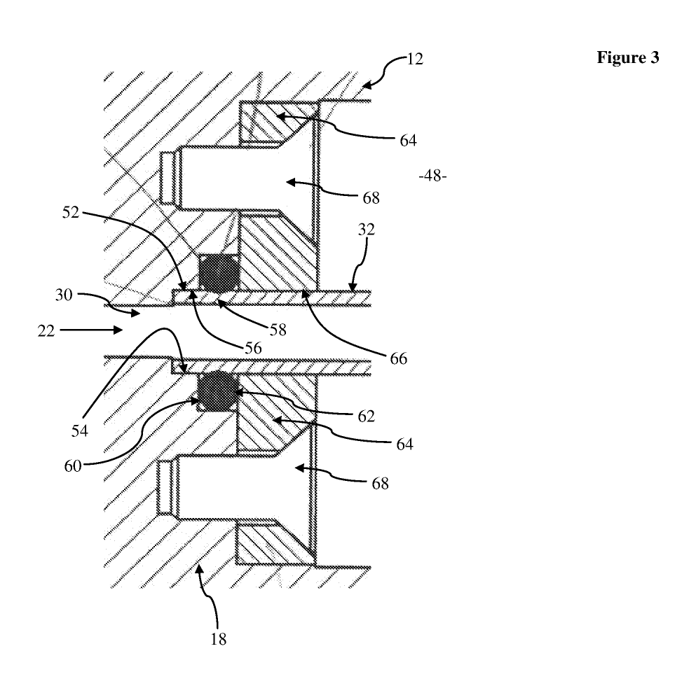

FIG. 3 is a further enlarged cross-sectional view of a transitional region between a sample-fluid flow passage leading from the pipe interior and past the valves and a sample tube which is received in part of the passage.

Referring to the drawings, there is shown a fluid conduit 10 having a sampling valve device 12, in this case being a process sampling device, connected to a portion of the side wall 14 thereof. In this case, the fluid conduit 10 is an elongate tubular fluid transport pipe, for example, for transporting natural gas, oil or other fluid to or from a refinery, or may be adapted to transport more hazardous substances. The pipe 10 therefore has the rigid solid side wall 14 and may in certain instances extend hundreds of kilometres between destinations. Furthermore, the pipe 10 may be supported above or below ground.

Although the invention is particularly relevant to pipework, the sampling valve device 12 may be utilised together with other forms of fluid container or fluid housings.

The sampling valve device 12 is preferably a double block and bleed valve device to meet safety requirements within the specific industry associated with the invention. However, other forms of valve device can be utilised, being an isolation type valve device, butterfly valve device, or ball valve device, by way of non-limiting examples.

The sampling valve device 12 comprises a mounting body 16 which in this case incorporates a valve body 18. The mounting body 16 is fluid tightly connectable to the side wall 14 of the pipe 10, typically via respective mounting flanges 20 which are boltable or otherwise engagable together with one or more fluid tight seals or gaskets sandwiched therebetween to prevent leakage to the surrounding environment.

The valve body 18 is typically forged metal and extends from the flanges 20. In the case of a double block and bleed valve system, as shown, on a flow path 22 therethrough two spaced apart isolation valves 24 are included interposed by a bleed valve 26. In the event that the isolation valves 24 must be closed, the bleed valve 26 can then be opened to discharge accumulated gas from a bleed chamber therebetween, thus reducing a pressure build up.

To enable samples to be collected, often continuously, from the fluid being transported in the pipe 10, a pipe-side or upstream sampling tube 28 extends from the mounting body 16, extending through the side wall 14 and into the pipe interior. The pipe-side sampling tube 28 defines part of a fluid-sample flow passage 30 forming at least part of the flow path 22 and which thus extends through the valve body 18 and on which the isolation valves 24 and bleed valve 26 are positioned.

Meeting the fluid-sample flow passage 30 in the valve body 18 is a valve-side or downstream sample tube 32 which terminates prior to the first isolation valve 24. The downstream sample tube 32 defines a further fluid-sample flow passage 34 which is contiguous or substantially contiguous with and/or received in the first said fluid-sample flow passage 30. Within the valve body 18, the downstream sample tube 32, in addition to at least a majority of the first said flow passage 30, is preferably, but not necessarily, straight, preventing or limiting undesirable pressure increases and restrictions as a fluid sample flows therealong. To this end, it is advantageous that the first and second fluid-sample flow passages 30, 34 have uniform or substantially uniform and matching or substantially matching lateral cross-sections along at least a majority of their respective longitudinal extents of at least portions which extend within the mounting body 16 and preferably beyond to either or both sides. It will be appreciated however, that only one or other of the downstream sample tube 32 or first flow passage 30 may be straight, if necessary.

To allow the downstream sample tube 32 to provide smoothly transitioning uniform or substantially uniform portions of the said flow path 22 with the first fluid-sample flow passage 30, the mounting body 16 has a connector recess 36 having an innermost or bottom surface 38 on which the first fluid-sample flow passage 30 opens. A sample-tube connector 40 is engagable with the connector recess 36. Any suitable engagement means can be considered, such as a twist-and-lock mechanism, however in this case an interior surface of the connector recess 36 and an exterior surface of the sample-tube connector 40 include complementary matable screw-threads for threadable engagement of the sample-tube connector 40 with the mounting body 16.

Preferably, to hold the downstream sample tube 32 in place, the sample-tube connector 40 includes a nut and ferrule arrangement at a projecting end thereof. This is known in the prior art, and is thus not shown in the drawings. As the nut is tightened onto the projecting end 42 of a body 44 of the sample-tube connector 40, typically to a specified torque, the ferrule is compressed, thereby gripping and holding the downstream sample tube 32 in place.

The sample-tube connector 40 thus has an axial through bore 46 which is complementarily shaped to slidably receive as a tolerance or close fit the downstream sample tube 32 therethrough. The sample tube 32 extends therefrom and passes through the connector recess 36 to meet and tightly engage with the first fluid-sample flow passage 30 at the bottom surface 38 of the connector recess 36. A cavity 48 thus defined by the connector recess 36 and the distal end 50 of the sample-tube connector 40 is bridged by the sample tube 32 connecting with the first fluid-sample flow passage 30.

To facilitate the connection between the first fluid-sample flow passage 30 and the downstream sample tube 32, in this embodiment, a proximal end portion 52 of the first fluid-sample flow passage 30 in the mounting body 16 at the connector recess 36 has a stepped bore 54. A first step 56 of the stepped bore 54 is complementarily shaped to receive an end portion 58 of the sample-tube connector 40. The shaping may be of a sufficient tolerance that a fluid tight or substantially fluid tight seal can be formed when the end portion 58 of the sample tube 32 is inserted and engaged with the first step 56 of the stepped bore 54. However, in this particular case, a second step 60 contiguous with the first step 56 is provided as part of the stepped bore 54. The second step 60 is downstream of the first step 56, and is shaped to receive a, preferably continuous, sealing element 62, for example being an O-ring seal, which fluid-tightly or substantially fluid-tightly seals the exterior surface of the sample tube 32 relative to the surface or surfaces of the second step 60.

With the sealing element 62 located, a sealing-element retainer 64, in this case preferably being a rigid inert-metal plate, is engagable with the interior bottom surface 38 of the connector recess 36. An aperture 66, in this case preferably centrally provided, allows for the downstream sample tube 32 to pass as a tolerance or close fit therethrough. A plurality of screw-threaded fasteners 68, in this case two or four being equi-angularly spaced apart around the aperture 66, is utilised to secure the sealing-element retainer 64 in place. Once mounted, the sealing-element retainer 64 thus tightly holds and covers the sealing element 62 on one side, trapping it against the second step 60 of the stepped bore 54.

Although the above-arrangement may be preferred in certain situations, for example, when using smaller mounting bodies and screw-threaded connections due to current manufacturing limitations, it may be feasible to dispense with the separate sealing-element retainer, in other words, the plate, and instead utilise the first step of the stepped bore to receive the end portion of the downstream sample tube whilst providing a sealing-element receiving portion integrally formed with the mounting body as one-piece. In this case, the sealing-element receiving portion would preferably include an undercut adapted to receive and prevent or limit axial displacement of the sealing element.

With the downstream sample tube 32 thus bridging the cavity 48 in the connector recess 36, the portion of the flow path 22 defined by the sample tube 32 is thus isolated from the remaining volume of the said cavity 48. The downstream sample tube 32 and the fluid-sample flow passage 30, having a smooth uniform transition together thus solely define the flow path 22 through the mounting body 16, connector recess 36, and sample-tube connector 40, which thereby significantly reduces or even prevents contamination of the fluid sample as it passes through the sampling valve device 12.

The device may be provided as a kit of parts. In this case, not all the parts may be installed or arrive together. For example, a valve body may be adapted to receive as a retrofit a sample-tube connection body, thus together then forming the mounting body. In this case, the sample-tube connection body may beneficially be a plate-like body typically including a connector aperture for connection of the sample-tube connector.

The sample-tube connection body would be coupled, for example, by bolting, to the valve body, for example, being a double block and bleed valve body, with a fluid-tight gasket or sealing element interposed therebetween. Following coupling, the connector aperture and the valve body thus create the connector recess and consequently the cavity which currently causes the contamination issues. By then utilising the further features of the invention described above allowing for the bridging of the cavity and thus the isolation of the fluid flow path from the contaminated area, improved sampling can be achieved.

Although the device described above is preferably a valve device, it is feasible that in some sampling applications the valve elements may be omitted or not required. As such, the valve body is omitted, and the mounting body which connects to the pipe or other fluid housing may thus be valveless.

It is thus possible to provide a, preferably process, sampling device, which advantageously may be in the form of a sampling valve and more preferably in the form of a double block and bleed valve device. The device prevents or reduces contamination of a fluid sample taken from a fluid conduit or other form of housing by utilising a bridging member, which is preferably specially treated to reduce or prevent surface defects which may lead to contamination. It is further possible to provide an overall approach or configuration which, by providing a contiguous or substantially contiguous flow path which is isolated or substantially isolated from a connector area in which contaminants tend to accumulate, the integrity of the fluid sample is maintained or at the very least significantly improved. By isolating the fluid flow from inferior surfaces, such as the screw-threaded areas at the sample-tube connector, sealant and thus correct connection can be maintained without the concern of contamination.

The words “comprises/comprising” and the words “having/including” when used herein with reference to the present invention are used to specify the presence of stated features, integers, steps or components, but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A sampling device comprising:
a mounting body connectable to a fluid-sample container, the mounting body having a fluid-sample flow passage opening into a connector recess;
a sample-tube connector engaged with the connector recess; and
a sample tube which extends from a distal end of the sample-tube connector and tightly engages with the fluid-sample flow passage, whereby a cavity defined by the connector recess and the distal end of the sample-tube connector is bridged by the sample tube.

2. The sampling device as claimed in claim 1, wherein a proximal end of the fluid-sample flow passage in the mounting body at the connector recess has a stepped bore.

3. The sampling device as claimed in claim 2, wherein a first step (56) of the stepped bore is complementarily shaped to receive an end portion of the sample-tube connector.

4. The sampling device as claimed in claim 3, wherein the said first step is adapted to fluid-tightly or substantially fluid-tightly engage with the end portion of the sample tube.

5. The sampling device as claimed in claim 3, wherein a second step of the stepped bore is shaped to receive a sealing element configured to fluid-tightly or substantially fluid-tightly seals an exterior surface of the sample tube (32) relative to the mounting body.

6. The sampling device as claimed in claim 5, further comprising a sealing-element retainer engagable with the mounting body configured to retain the sealing element in the stepped bore.

7. The sampling device as claimed in claim 6, wherein the sealing-element retainer is a plate engagable with an interior surface of the connector recess and through which the sample tube is extendable.

8. The sampling device as claimed in claim 3, further comprising a sealing-element receiving portion integrally formed with the mounting body as one-piece, the sealing-element receiving portion including an undercut adapted to receive and prevent or limit axial displacement of a sealing element.

9. The sampling device as claimed in claim 1, wherein the sample-tube connector includes a compressible ferrule configured to which grip the sample tube.

10. The sampling device as claimed in claim 1, wherein the sample tube has a uniform or substantially uniform lateral cross-section along a longitudinal extent of at least a portion extending within the sampling device.

11. The sampling device as claimed in claim 10, wherein the sample tube has a uniform unstepped bore within at least a portion extending within the sampling device, the said uniform unstepped bore matching or substantially matching at least a major portion of a bore of the fluid-sample flow passage.

12. The sampling device as claimed in claim 1, wherein the sample tube is contiguous with the said fluid-sample flow passage.

13. The sampling device as claimed in claim 1, wherein the sample tube defines an isolated flow path through the said cavity.

14. The sampling device as claimed in claim 1, wherein the sample tube and the fluid-sample flow passage together solely define a flow path through the mounting body, connector recess, and sample-tube connector.

15. The sampling device as claimed in claim 1, wherein the mounting body is part of a valve.

16. The sampling device as claimed in claim 15, wherein the fluid-sample flow passage extends from one end of the mounting body to be receivable in a fluid-sample container housing a fluid requiring sampling.

17. The sampling device as claimed in claim 1, wherein the mounting body, sample-tube connector and sample tube are in the form of a kit of parts.

18. (canceled)

19. A fluid-sample container comprising an elongate hollow tubular body and a sampling device as claimed in claim 1 connected to a side thereof, the said fluid-sample flow passage extending from the mounting body into an interior of the elongate hollow tubular body.

20. A method of preventing or reducing contamination of a fluid sample extracted from a fluid flow in a fluid-sample container, the method comprising the step of providing an isolated flow path bridging an internal cavity defined by a connector recess of a mounting body and a distal end of a sample-tube connector, the isolated flow path isolating a sample fluid flow through the said internal cavity.

21. The sampling device as claimed in claim 1, wherein the sampling device is configured to house a fluid requiring sampling.
